(19) United States
(12) Patent Application Publication
(10) Pub. No.: US 2026/0311907 A1
(43) Pub. Date: Oct. 8, 2026

(54) CONFINEMENT ASSEMBLY GROUND PLANE FOR RADIO FREQUENCY (RF) FIELD CONTROL

(71) Applicant: Quantinuum LLC, Broomfield, CO (US)

(72) Inventors: William J. BAKER, Broomfield, CO (US); David A. DEEN, Edina, CO (US); Todd Michael KLEIN, Wayzata, MN (US)

(21) Appl. No.: 19/211,922

(22) Filed: May 19, 2025

Related U.S. Application Data
(60) Provisional application No. 63/664,900, filed on Jun. 27, 2024.

(51) Int. Cl. G21K 1/20; G06N 10/40

(52) U.S. Cl. CPC G21K 1/20; G06N 10/40

(57) ABSTRACT

A confinement assembly is provided that includes an electrode layer comprising a plurality of electrodes, one or more routing layers configured to provide respective voltage signals to respective electrodes; and a ground plane comprising a set of features in electrical communication with one another and a load ground point connection. The electrodes include at least one radio frequency (RF) electrode and are operable to generate a confinement potential configured to confinement atomic objects. The respective voltage signals provided via the routing layers include an RF voltage signal configured to be provided to the RF electrode. The set of features is in electrical communication with the RF electrode and configured to guide a return RF current to ground along an at least partially constrained path. The return RF current is generated responsive to the RF voltage signal being provided to the RF electrode.

### CROSS-REFERENCE TO RELATED APPLICATION(S)

The application claims priority to U.S. Application No. 63/664,900, filed Jun. 27, 2024, the content of which is incorporated hereby by reference in its entirety.

### TECHNICAL FIELD

Embodiments described herein generally relate to a ground plane for a confinement apparatus. An example embodiment relates to a ground plane for a confinement apparatus configured for controlling magnetic fields generated by radio frequency (RF) return currents.

### BACKGROUND

An ion trap with surface radio frequency (RF) electrodes normally includes a ground plane disposed within the stack below the top metal layer. The ground plane shields other signals and provides a path for the RF currents to return to ground. When the RF electrodes are driven with a frequency on the order of 1-100 MHz, for example, the return current includes substantial contributions from both reactive currents and resistive currents. Common qubit states in trapped ion quantum computing systems are sensitive to spurious magnetic fields, as the energy levels of the ions used as the qubits are due to a coupling of the ions' spin degree of freedom with magnetic fields. As moving charged particles, the return RF current generates a magnetic field that will also interact with the ions' spin degree of freedom. Through applied effort, ingenuity, and innovation many deficiencies of such systems have been solved by developing solutions that are structured in accordance with the embodiments of the present invention, many examples of which are described in detail herein.

### BRIEF SUMMARY OF EXAMPLE EMBODIMENTS

Example embodiments provide a ground plane for a confinement assembly, a confinement assembly including a ground plane, and/or systems that include confinement assemblies that include ground planes. The confinement assembly includes an electrode layer that includes at least one radio frequency (RF) electrode configured to have an RF voltage signal applied thereto. The ground plane provides a path for return RF currents to return to ground. In various embodiments, the ground plane includes a set of features in electrical communication with one another and with the at least one RF electrode. The set of features are configured to guide a return RF current to ground. In various embodiments, the set of features are configured to guide the return RF current to ground along a path that controls the magnetic field generated by the return RF current.

According to a first aspect, confinement assembly is provided. In various embodiments, the confinement assembly includes an electrode layer comprising a plurality of electrodes, the plurality of electrodes comprising at least one radio frequency (RF) electrode and operable to generate a confinement potential configured to confine atomic objects; one or more electrical routing layers configured to provide respective voltage signals to respective electrodes of the plurality of electrodes, the respective voltage signals comprising an RF voltage signal configured to be provided to the at least one RF electrode; and a ground plane comprising a set of features in electrical communication with one another and with at least one RF electrode and configured to guide a return RF current to ground, the return RF current generated responsive to the RF voltage signal being provided to the at least one RF electrode.

In an example embodiment, the RF voltage signal is characterized by a frequency in a range of 1 to 100 MHz.

In an example embodiment, a geometry of the set of features enables one or more vias to conduct a respective voltage signal to a respective electrode of the plurality of electrodes from the one or more routing layers through the ground plane.

In an example embodiment, the return RF current comprises a resistive current and a reactive current and a geometry of the set of features is configured to constrain at least a portion of a path of the resistive current.

In an example embodiment, the geometry of the set of features constrains the path of the resistive current to flow along a path of the reactive current.

In an example embodiment, the geometry of the set of features is configured to cause the magnetic fields generated by the return RF current to at least partially cancel the magnetic fields generated by an RF current driven in the at least one RF electrode by application of the RF voltage signal thereto.

In an example embodiment, the magnetic fields as a result of the return current is in an opposite direction of the magnetic fields generated by the driven RF electrode.

In an example embodiment, a cross-sectional area of one or more features of the set of features is configured to control a current density of the return RF current flowing through the one or more features.

In an example embodiment, the cross-sectional area of the one or more features is configured to control a magnitude of the return magnetic field at one or more locations defined at least in part by the plurality of electrodes.

In an example embodiment, a geometry of at least a subset of the set of features has a same shape as a geometry of the at least one RF electrode.

In an example embodiment, the set of features is configured to control a path and a current density of the return RF current.

In an example embodiment, the set of features is configured to control the path and the current density of the return RF current so as to control a direction and magnitude of a return magnetic field generated by the return RF current.

In an example embodiment, the set of features is fabricated via subtractive patterning.

In an example embodiment, the set of features is fabricated via additive patterning.

According to an example embodiment, a quantum computer is provided. The quantum computer includes a confinement assembly. The confinement assembly includes an electrode layer comprising a plurality of electrodes, the plurality of electrodes comprising at least one radio frequency (RF) electrode and operable to generate a confinement potential configured to confine a plurality of atomic objects; one or more electrical routing layers configured to provide respective voltage signals to respective electrodes of the plurality of electrodes, the respective voltage signals comprising an RF voltage signal configured to be provided to the at least one RF electrode; and a ground plane comprising a set of features in electrical communication with one another and with at least one RF electrode and configured to guide a return RF current to ground, the return RF current generated responsive to the RF voltage signal being provided to the at least one RF electrode.

In an example embodiment, the quantum computer further includes a plurality of voltage sources configured to generate the respective voltage signals.

In an example embodiment, the atomic objects are hyperfine qubits, the return RF current comprises a resistive current and a reactive current, and a geometry of the set of features is configured to constrain a path of the resistive current so as to control a magnetic field generated thereby.

In an example embodiment, the RF voltage signal is characterized by a frequency in a range of 1 to 100 MHz.

In an example embodiment, a geometry of the set of features enables one or more vias to conduct a respective voltage signal to a respective electrode of the plurality of electrodes from the one or more routing layers through the ground plane.

In an example embodiment, the return RF current comprises a resistive current and a reactive current and a geometry of the set of features is configured to constrain at least a portion of a path of the resistive current.

In an example embodiment, the geometry of the set of features constrains the path of the resistive current to flow along a path of the reactive current.

In an example embodiment, the geometry of the set of features is configured to cause a return magnetic field generated by the return RF current to at least partially cancel a driven magnetic field generated by a driven RF current driven in the at least one RF electrode by application of the RF voltage signal thereto.

In an example embodiment, the return magnetic field is in an opposite direction of the driven magnetic field.

In an example embodiment, a cross-sectional area of one or more features of the set of features is configured to control a current density of the return RF current flowing through the one or more features.

In an example embodiment, the cross-sectional area of the one or more features is configured to control a magnitude of the return magnetic field at one or more locations defined at least in part by the plurality of electrodes.

In an example embodiment, a geometry of at least a subset of the set of features has a same shape as a geometry of the at least one RF electrode.

In an example embodiment, the set of features is configured to control a path and a current density of the return RF current.

In an example embodiment, the set of features is configured to control the path and the current density of the return RF current so as to control a direction and magnitude of a return magnetic field generated by the return RF current.

In an example embodiment, the geometry of the set of features is configured to cause a return magnetic field generated by the return RF current to at least partially cancel a driven magnetic field generated by a driven RF current driven in the at least one RF electrode by application of the RF voltage thereto.

In an example embodiment, the return magnetic field is in an opposite direction of the driven magnetic field.

In an example embodiment, a geometry of the set of features is configured to control a direction and magnitude of a return magnetic field at one or more locations defined at least in part by the plurality of electrodes, the plurality of electrodes configured to confine one or more of the plurality of atomic objects at respective locations of the one or more locations.

In an example embodiment, the return magnetic field at the one or more locations is configured to at least partially cancel out the magnetic field generated by the driven RF current at the one or more locations.

In an example embodiment, the confinement assembly further comprises an insulator layer disposed between the electrode layer and the ground plane.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example quantum charge-coupled device (QCCD)-based quantum computer, in accordance with an example embodiment.

FIG. 2A cross-sectional view of a portion of an example confinement assembly including a ground plane, according to an example embodiment.

FIG. 2B provides a top view of a portion of an example confinement assembly, according to an example embodiment.

FIG. 3A provides a cross-sectional view of a conventional confinement assembly including a conventional ground plane.

FIG. 3B illustrates the magnetic fields at a target location of the conventional confinement assembly.

FIG. 3C provides a schematic cross-sectional view of a portion of a confinement assembly, according to an example embodiment.

FIG. 3D illustrates the magnetic fields at a target location of the confinement assembly illustrated in FIG. 3C.

FIG. 4A provides a top view of an example at least one RF electrode of a confinement assembly, according to an example embodiment.

FIG. 4B provides a top view of an example ground plane of the example confinement assembly shown in FIG. 4A.

FIG. 4C provides a cross-sectional view of the example ground plane of the example confinement assembly shown in FIG. 3B.

FIG. 5 provides a schematic diagram of an example controller of a quantum computer comprising a confinement apparatus, in accordance with an example embodiment.

FIG. 6 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “substantially,” “generally,” and “approximately” refer to within appropriate engineering and/or manufacturing tolerances and/or within user measurement capabilities, unless otherwise indicated. Like numbers refer to like elements throughout.

Various embodiments provide a ground plane for a confinement assembly, a confinement assembly including a ground plane, and/or systems that include confinement assemblies that include ground planes. The ground plane includes a set of features that are in electrical communication with one another. The confinement assembly includes an electrode layer that includes at least one radio frequency (RF) electrode that is in electrical communication with the set of features such that the set of features are configured to guide a return RF current to ground. RF refers to a frequency range of approximately 10 kHz-300 GHz. When an RF voltage signal is applied to the at least one RF electrode, the set of features of the ground plane provide a path for a return RF current to return to ground. In various embodiments, the set of features are configured to guide the return RF current to ground along a path that controls the magnetic field generated by the return RF current.

For example, an RF voltage source is applied to the at least one RF electrode to cause generation of a confining potential configured to confine atomic objects. This causes a driven RF current to propagate through the at least one RF electrode. In order to complete the circuit, the at least one RF electrode is in electrical communication with the ground plane to provide a return RF current path to a load ground point connection. Conventionally, the ground plane of a confinement assembly is a conductive sheet or layer.

When the RF voltage signal is characterized by lower frequencies (e.g., 1 kHz), the return RF current distribution is dominated by a resistive current. The resistive current is governed by a real resistive path-length minimization process at least one RF electrode and the load ground point connection. When the RF voltage signal is characterized by higher frequencies (e.g., 1 GHz) the return RF current distribution is dominated by reactive currents which are governed by a minimization of the device impedance. The reactive currents tend to flow along a similar pattern as the driven RF currents. For example, the reactive currents may flow through the ground plane in the same pattern and in corresponding positions as the driven RF currents flowing through the at least one RF electrode (but in opposite direction).

When the RF voltage signal applied to the RF electrodes is characterized by a frequency on the order of 10s of MHz, the return current includes substantial contributions from both reactive currents and resistive currents. The reactive currents mirror the currents in the RF electrodes. The resistive currents, however, will take a more direct path to ground.

As a current necessarily includes moving charged particles, the return RF current generates a magnetic field. The different paths to the load ground point connection of the resistive currents and the reactive currents causes the magnetic field generated by the return RF current to include components in various directions.

Common qubit states in trapped ion and/or QCCD-based quantum computing systems are based on the hyperfine splitting of the atomic objects (e.g., neutral and/or ionic atoms; neutral, ionic, or multipolar molecules; and/or the like) used as the qubits of the quantum computing system. Thus, the qubits states are sensitive to spurious magnetic fields, as the hyperfine splitting energy levels of the atomic objects used as the qubits are due to a coupling of the atomic objects' spin degree of freedom with magnetic fields. Therefore, it is desired to control the return RF currents such that the magnitude and direction of magnetic fields and magnetic field gradients generated by the return RF currents (possibly in combination with the magnetic fields and magnetic field gradients generated by the driven RF currents) are controlled and/or reduced.

Therefore, the magnetic fields generated by the return RF currents may affect the qubit states of the quantum computing system. This may lead to memory errors, lower fidelity quantum logic gates, and/or the like. Thus, technical problems regarding controlling the magnetic field generated by various currents flowing through various layers of a confinement assembly exist.

Various embodiments provide technical solutions to these technical challenges. In particular, the ground plane comprises a set of features that are in electrical communication with one another. The set of features are configured to guide the return RF current to the load ground point connection. For example, the geometry of the ground plane is modified from a conventional ground plane the geometry so as to control the path traversed by the various components of the return RF current. For example, the ground plane may be modified to provide a set of effective trace-like domains or features that guide the resistive currents along desired trajectories or paths. In some embodiments, the set of features corresponds to the path the reactive currents would naturally take. For example, the set of engineered features may mimic or mirror the RF electrode geometry of the at least one RF electrode. In various embodiments, the set of features are configured to provide a controlled magnetic field as a result of the reactive and resistive currents flowing therethrough.

Various embodiments provide confinement assemblies that include ground planes comprising a set of features configured to control a path of various components of the return RF current. Various embodiments provide systems that includes such confinement assemblies. In various embodiments, the modified geometry of the ground plane of such embodiments reduces the spurious magnetic fields experienced by atomic objects confined by the confinement apparatus of the confinement assembly. The reduced spurious magnetic fields experienced by the atomic objects results enables higher fidelity of operations performed by the system.

Therefore, various embodiments provide technical improvements to the fields of confinement assemblies, atomic systems including confinement assemblies, quantum systems including confinement assemblies, and QCCD-based and/or atomic qubit quantum computing.

### Example Quantum Computer System

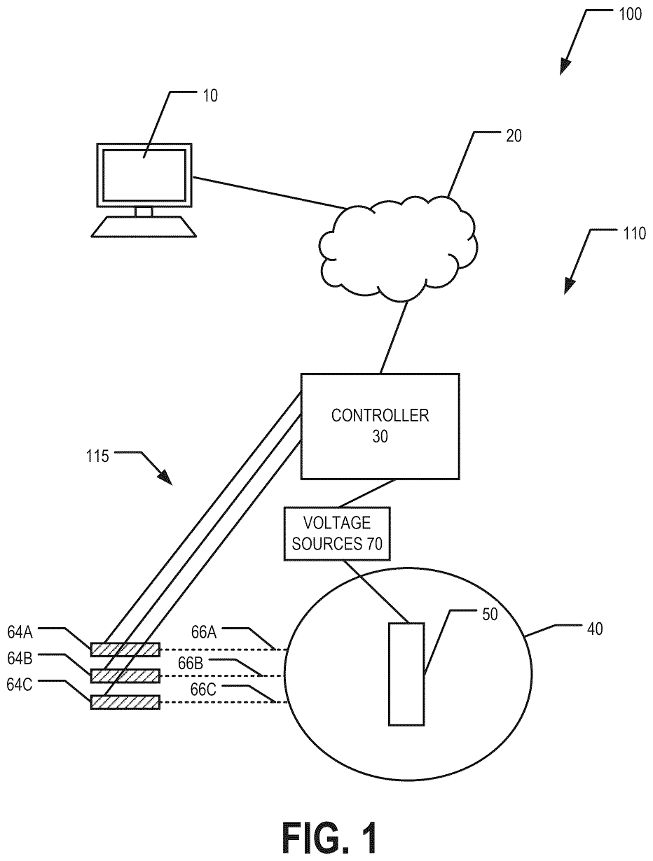

FIG. 1 provides a block diagram of an example QCCD-based and/or atomic qubit quantum computer system 100 that includes a confinement assembly 50 having a ground plane in accordance with an example embodiment. In various embodiments, the quantum computer system 100 comprises a classical (e.g., semiconductor-based) computing entity 10 and a quantum computer 110. In various embodiments, the quantum computer 110 comprises a controller 30 and a quantum processor 115. In various embodiments, the quantum processor 115 includes a cryogenic and/or vacuum chamber 40 enclosing a confinement assembly 50, one or more manipulation sources 64 (e.g., 64A, 64B, 64C), one or more voltage sources 70, an optics collection system (not shown), and/or the like.

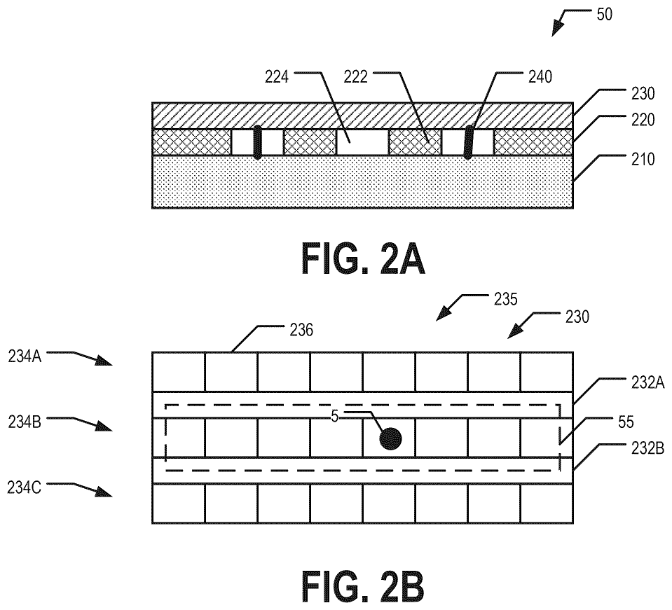

In various embodiments, the confinement assembly 50 includes a ground plane in accordance with an example embodiment and a confinement apparatus 235. The confinement apparatus 235 is defined, at least in part, by an electrode layer 230 of the confinement assembly 50 (see FIG. 2B). The confinement apparatus 235 is configured to confine a plurality of atomic objects. For example, the confinement apparatus 235 confines the plurality of atomic objects for use as qubits (e.g., hyperfine qubits) of the quantum computer 110 and/or for use as cooling objects to sympathetically cool the qubits. In various embodiments, the quantum computer 110 comprises a plurality of voltage sources 70 (e.g., such as arbitrary waveform generators (AWGs), digital-analog converters (DACs), and/or the like) used to control operation of the confinement apparatus 235. For example, the controller 30 is configured to control operation of the plurality of voltage sources 70 so as to control the operation of the confinement apparatus 235.

In various embodiments, the confinement apparatus 235 is an ion trap. For example, the confinement apparatus 235 may be a surface ion trap, Paul ion trap, and/or the like. For example, the electrode layer 230 of the confinement assembly 50 comprises a plurality of electrodes. In an example embodiment, the confinement apparatus 235 comprises at least one radio frequency (RF) electrodes configured to receive an RF voltage signal generated by at least one of the voltage sources 70 applied thereto. Responsive to the RF voltage signal being applied to the at least one RF electrode, a trapping pseudopotential configured to confine atomic objects is generated. For example, the at least one RF electrode is operable to generate a confinement potential configured to confine atomic objects.

In an example embodiment, the one or more manipulation sources 64 comprise one or more lasers (e.g., optical lasers, and/or the like), microwave field sources, and/or the like. In various embodiments, the one or more manipulation sources 64 are configured to generate and provide manipulation signals that are used to manipulate and/or cause a controlled quantum state evolution of one or more atomic objects confined by the confinement apparatus 235. For example, in an example embodiment, wherein the one or more manipulation sources 64 comprise one or more lasers, the lasers may provide one or more laser beams to the confinement apparatus 235 within the cryogenic and/or vacuum chamber 40. In another example, the manipulation sources 64 may include one or more microwave sources configured to provide microwave signals to the confinement apparatus 235.

In various embodiments, the manipulation sources 64 may be used to generate manipulation signals that are used to perform quantum logic operations, shelving/deshelving operations, measurement operations, cooling operations, state preparation operations, and/or the like. In an example embodiment, the one or more manipulation sources 64 each provide a laser beam and/or the like to the confinement apparatus 235 via a corresponding beam path system 66 (e.g., 66A, 66B, 66C). For example, a beam path system 66 is configured to provide a manipulation signal generated by a respective manipulation source 64 to a respective target location 5 defined at least in part by the confinement apparatus 235. In various embodiments, at least one beam path system 66 comprises a modulator configured to modulate the manipulation signal being provided to the confinement apparatus 235 via the beam path system 66. In various embodiments, the manipulation sources 64, active components of the beam path systems 66 (e.g., modulators and/or the like), and/or other components of the quantum processor 115 are controlled by the controller 30.

In various embodiments, the quantum computer 110 comprises an optics collection system. In various embodiments, the optics collection system 80 comprises one or more photodetectors (e.g., photodiodes, avalanche photodiodes, photomultiplier tubes, phototransistors charge-coupled devices (CCDs), complementary metal-oxide-semiconductor (CMOS) photon sensors, and/or the like) configured to detect photons fluoresced and/or emitted by qubit ions (e.g., during a measurement operation). The optics collection system may further include various optical components (e.g., lenses, reflectors, metasurfaces, waveguides, optical fibers, and/or the like) configured to direct photons fluoresced and/or emitted by atomic objects to respective photodetectors. The photodetectors are configured to generate and provide respective sensor signals that indicate and/or encode when and/or how many photons are detected thereby. The sensor signals are provided to the controller 30 for processing.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand, execute, and/or implement.

In various embodiments, the controller 30 is configured to control voltage sources 70 controlling the operation of the confinement apparatus 235 and/or confinement and transport of atomic objects confined by the confinement apparatus 235; a cryogenic system and/or vacuum system controlling the temperature, pressure, and/or other environmental parameters within the cryogenic and/or vacuum chamber 40; manipulation sources 64; beam path systems 66; and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more ions confined by the confinement apparatus 235. In various embodiments, the controller 30 is configured to receive sensor signals generated by photodetectors of the optics collection system.

### Example Confinement Assembly

Various embodiments provide a confinement assembly including a ground plane having a geometry that is modified to control a path of a return RF current therethrough. FIG. 2A provides a schematic cross-sectional view of a portion of an example confinement assembly 50 and FIG. 2B provides a schematic top view of the portion of the example confinement assembly 50.

In various embodiments, the confinement assembly 50 includes an electrode layer 230. The electrode layer 230 includes a plurality of electrodes. The plurality of electrodes includes at least one radio frequency (RF) electrode 232A, 232B. The at least one RF electrode 232A, 232B is operable to generate a confinement potential configured to confine atomic objects. For example, when an RF voltage signal (e.g., generated by a voltage source 70) is applied to the electrode RF electrodes 232A, 232B, the RF electrodes 232A, 232B generate the confinement potential.

In various embodiments, the confinement apparatus 235 is at least partially defined by a number of RF electrodes 232 (e.g., 232A, 232B). While the RF electrodes 232 are illustrated as generally rectangular, in various embodiments, the RF electrodes 232 may have various geometries, as appropriate for the application. In various embodiments, the plurality of electrodes of the electrode layer 230 includes a number of sequences of control electrodes 234 (e.g., 234A, 234B, 234C). Each sequence of control electrodes 234 comprises a plurality of control electrodes 236. While the control electrodes 236 are illustrated as generally rectangular, in various embodiments, the control electrodes 236 may have various geometries, as appropriate for the application.

In various embodiments, the operation of the at least one RF electrode 232 defines one or more confinement regions 55 and operation of the control electrodes 236 controls the location and/or transportation of atomic objects within/along the one or more confinement regions 55. For example, one or more target locations 5 may be defined within the confinement region(s) 55 of the confinement apparatus 235 defined by the plurality of electrodes (e.g., the at least one RF electrode 232 and the sequences of control electrodes 234).

In various embodiments, the confinement assembly 50 comprises one or more electrical routing layers 210. The routing layers 210 are configured to provide respective voltage signals to respective electrodes of the plurality of electrodes. For example, the respective voltage signals generated by the voltage sources 70 may be directed to respective electrodes of the plurality of electrodes via the one or more routing layers 210. For example, an RF voltage signal is directed to the at least one RF electrode via the one or more routing layers 210.

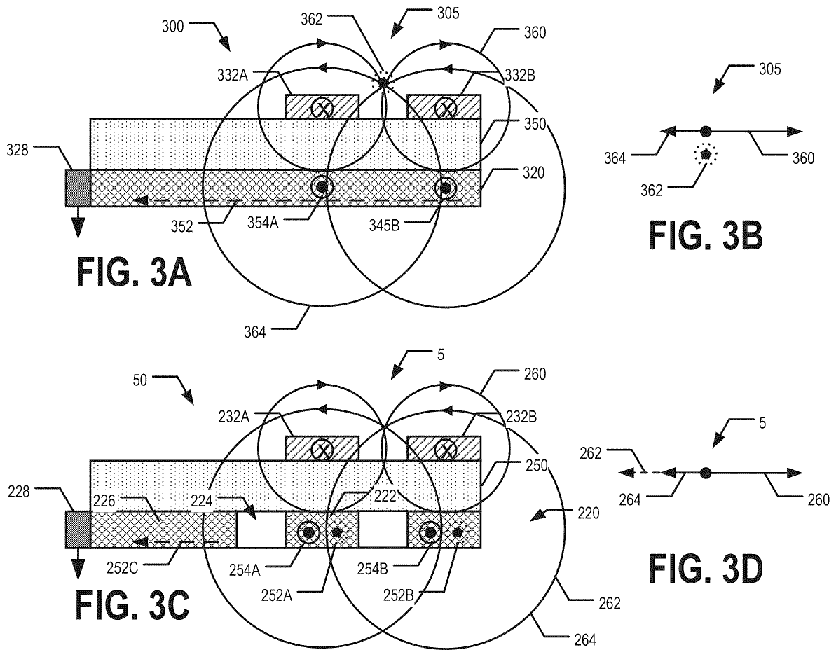

In various embodiments, the confinement assembly 50 further includes a ground plane 220. The ground plane 220 includes a set of features 222 that are in electrical communication with one another and with the at least one RF electrode. The ground plane 220 is configured to guide a return RF current to ground (e.g., a load ground point connection). In an example embodiment, one or more dielectric and/or insulator layers 250 may be disposed between the ground plane 220 and the electrode layer 230, as shown in FIG. 3C.

FIG. 3A illustrates a cross-section of a conventional confinement assembly 300. The conventional confinement assembly 300 includes RF electrodes 332A, 332B, a dielectric layer 350, and a conventional ground plane 320. The conventional ground plane 320 is a conductive sheet or layer that provides a path for a return RF current to the load ground point connection 328.

As shown in FIG. 3A, an RF voltage signal is applied to the RF electrodes 332A, 332B. In various scenarios, the RF voltage signal is characterized by a frequency in the 10s of MHz such that the return RF current includes significant contributions from both the reactive current and resistive current. In the illustrated conventional confinement assembly 300, the driven RF current is flowing through the RF electrodes 332A, 332B into the page. This results in the reactive current component 354A, 354B of the return RF current to flow out of the page and the resistive current component 352 to flow to the left (e.g., directly toward the load ground point connection 328).

FIG. 3B illustrates the magnetic fields generated by the driven RF current and the components of the return RF current at a target location 305. The driven magnetic field 360, generated by the driven RF current is characterized by (e.g., points in) a first direction. The reactive component 364 of the return magnetic field, which is generated by the reactive current component of the return RF current, is characterized by (e.g., points in) a second direction. The first direction and the second direction are opposite directions. For example, the first direction and second direction are 180 degrees apart from one another.

The resistive component 362 of the return magnetic field, which is generated by the resistive current component of the return RF current, is characterized by (e.g., points in) a third direction. The third direction in the illustrated example is into the page. However, the third direction has no predefined relationship with the first or second direction, as the resistive current 352 merely takes the most direct path (e.g., the path of least resistance) to the load ground point connection 328. The resulting return magnetic field at the target location 305 (e.g., the vector sum of the reactive component 364 and the resistive component 362) is complicated.

FIG. 3C illustrates a cross-section of a portion of an example confinement assembly 50 that includes an electrode layer 230 including RF electrodes 232A, 232B, one or more dielectric and/or insulator layers 250, and a ground plane 220. The ground plane comprises a plurality of features 222 that are in electrical communication with one another and configured to provide a path for the return RF current to the load ground point connection 228. In various embodiments, the features 222 are formed of and/or comprise a conductive material such as one or more high-conductivity metals or an alloy thereof (e.g., gold, copper, aluminum, AlCu, titanium, TiPt, TiW, and/or the like) or one or more high-conductivity semiconductor(s) and/or a structure there of (e.g., degenerately doped silicon, 3-dimensional and/or 2-dimensional charge gasses, and/or the like).

In various embodiments, spaces or gaps 224 are disposed between at least portions of features 222. In an example embodiments, the spaces or gaps 224 are filled with and/or include a dielectric or insulative material. For example, the spaces or gaps 224 may be filled with and/or include an insulating material such as insulating dielectric (e.g., silicon, silicon dioxide, silicon nitride, Al₂O₃, other oxide and/or nitride, and/or the like).

As shown in FIG. 3C, an RF voltage signal is applied to the RF electrodes 232A, 232B. In various embodiments, the RF voltage signal is characterized by a frequency in the 10s of MHz (e.g., in a range of 1 to 100 MHz), resulting in a return RF current that includes significant contributions from both the reactive current and resistive current. In the illustrated confinement assembly 50, the driven RF current is flowing through the RF electrodes 232A, 232B into the page. This results in the reactive current component 254A, 254B of the return RF current to flow out of the page.

The geometry of the set of features 222 is configured to constrain at least a portion of a path of the resistive current. For example, due to the geometry of the ground plane 220 as a result of being formed of the plurality of features 222, the resistive current component 252A, 252B near the target location 5 also flows out of the page. In particular, the set of features 222 of the ground plane 220 are configured to control the flow of the return RF current (e.g., the resistive current and the reactive current) to cause a desired return magnetic field at the target location 5. For example, the plurality of features 222 of the ground plane 220 are configured to cause the resistive current 252A, 252B near the target location 5 to flow along a path that is similar to the path of the reactive current 254A, 254B. In an example embodiment, the geometry of the set of features 222 of the ground plane 220 is configured to constrain a path of the resistive current to flow along a path of the reactive current.

In an example embodiment, the ground plane 220 includes a well feature 226, which may be the feature 222 that is in direct electrical communication with the load ground point connection 228 (e.g., there are no other features 222 between the load ground point connection 228 and the well feature 226). As the magnitude of a magnetic field decreases with the inverse of distance (e.g., 1/r, where r is the distance from the current), and the well feature 226 is located further from the target location 5 than the other features 222 of the ground plane 220, the magnetic fields generated by the return RF current flowing through the well feature 226 has minimal effect on the total magnetic field at the target location. Therefore, in some embodiments, the well feature 226 is configured to provide a low resistance path to the load ground point connection 228.

While FIG. 3C illustrates the path of the return RF current within a single metal plane or layer, in some embodiments, the path of the return RF current is provided through more than one metal plane or layer. For example, confinement assembly 50 may include a plurality of metal planes or layers having dielectric and/or insulator layers 250 therebetween. The path of the return RF current may be defined through respective portions of two or more metal planes or layers of the plurality of metal planes or layers, in certain embodiments. For example, the ground plane may be defined in one or more metal planes or layers of the confinement assembly 50.

FIG. 3D illustrates the magnetic fields generated by the driven RF current and the components of the return RF current at a target location 5. The driven magnetic field 260, generated by the driven RF current in the RF electrodes 232A, 232B is characterized by (e.g., points in) a first direction. The reactive component 264 of the return magnetic field, which is generated by the reactive current component of the return RF current, is characterized by (e.g., points in) a second direction. The first direction and the second direction are opposite directions. For example, the first direction and second direction are 180 degrees apart from one another.

The resistive component 262 of the return magnetic field, which is generated by the resistive current component of the return RF current, is characterized (e.g., points in) a third direction. The features 222 of the ground plane 220 are configured such that the third direction is parallel to and/or the same direction as the second direction. The resulting return magnetic field at the target location 5 (e.g., the vector sum of the reactive component 264 and the resistive component 262) is therefore in the second direction. As the second direction is opposite the first direction, the return magnetic field at least partially cancels out the driven magnetic field 260, resulting in a smaller, well-controlled magnetic field at the target location 5. For example, the geometry of the set of features 222 is configured to cause a return magnetic field generated by the return RF current to at least partially cancel out a driven magnetic field generated by a driven RF current driven in the RF electrodes 232A, 232B by application of the RF voltage signal thereto.

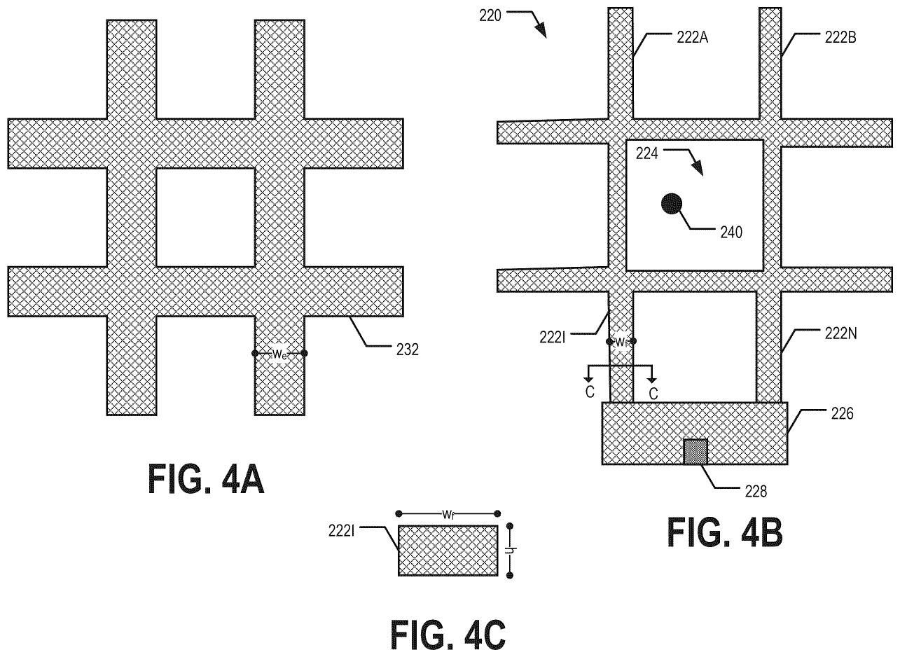

In various embodiments, the cross-sectional area of the features is configured to control a current density of the return RF current flowing therethrough. For example, FIG. 4A illustrates an example RF electrode 232 of an example confinement assembly 50. FIG. 4B illustrates an example ground plane 220 of the example confinement assembly 50 that includes a plurality of features 222A, 222B, . . . , 222N. The plurality of features also includes well feature 226 which is in direct electrical communication with the load ground point connection 228. FIG. 4C illustrates a cross-section of a feature 222I of the ground plane 220 shown in FIG. 4B taken along line CC. The feature has a feature width w_{f} that is measured in a direction that is in a plane defined by the ground plane and that is perpendicular to the direction which current will flow through the feature. The feature has a feature height h measured in a direction that is perpendicular to the plane defined by the ground plane.

In various embodiments, the feature width w_{f} and/or the feature height h are controlled to constrain and/or control the current density of the return RF current flowing through the features 222. For example, the cross-sectional area of the one or more features (defined by the feature height h and the feature width w_{f}) is configured to control a magnitude of the return magnetic field at one or more locations defined at least in part by the confinement apparatus by controlling the current density of the return RF current.

As shown in FIG. 4A, an RF electrode 232 has an electrode width wₑ in a direction that is in a plane parallel to the plane defined by the ground plane 220 and in a direction that is perpendicular to the flow of current through the RF electrode 232. In various embodiments, the electrode width wₑ is greater than or equal to the feature width w_{f}. In some embodiments, the electrode width wₑ is less than the feature width w_{f}. In various embodiments, the electrode width wₑ may not be uniform and/or consistent at all points along the one or more RF electrodes 232 and/or the feature width w_{f} may not be uniform and/or consistent for all features 222 and/or along a particular feature 222. For example, a well feature 226 is an example of a feature 222 that may have a different width compared to other features 222.

As shown in FIG. 4B, a geometry or layout of the set of features 222 enables one or more vias 240 to conduct a respective voltage signal to a respective electrode 232, 236 of the plurality of electrodes from the one or more routing layers 210. For example, vias 240 routing electrical signals between the one or more routing layers 210 and the electrode layer 230 may pass through the openings or gaps 224 between the features 222.

In various embodiments, the geometry or layout of the set of features 222 has a same or similar shape as the geometry and/or layout of the at least one RF electrode 232. For example, set of features 222 of the ground plane 220 shown in FIG. 4B is the same shape as the RF electrode 232 illustrated in FIG. 4A. For example, the set of features 222 is configured to control a path and current density of the return RF current. For example, the set of features 222 may be configured to control a path the return RF current such that the return RF current has a predetermined spatial relationship with the driven RF current. For example, the set of features 222 may be configured to control a current density of the return RF current such that a ratio of the current density of the return RF current to the current density of the driven RF current is within a pre-set and/or pre-determined range. For example, the set of features 222 may be configured to control the path and/or current density of the return RF current so as to control a direction and magnitude of the return magnetic field generated by the return RF current at one or more target locations 5 defined at least in part by the confinement apparatus 235 (e.g., the plurality of electrodes of the electrode layer 230). For example, the set of features 222 may be configured to control the path and/or current density of the return RF current such that the return magnetic field generated by the return RF current at one or more target locations 5 defined at least in part by the confinement apparatus 235 (e.g., the plurality of electrodes of the electrode layer 230) is in a direction that is opposite the driven magnetic field generated by the driven RF current flowing through a respective RF electrode 232, at the respective target locations 5. This causes the return magnetic field to at least partially cancel the driven magnetic field at the one or more target locations 5.

In various embodiments, one or more of a variety of techniques may be leveraged for patterning the set of features 222 of the modified geometry of the ground plane 220 of a confinement assembly 50. For example, subtractive patterning (e.g., wet etching, dry etching, polishing, and/or the like) may be leverage for patterning the ground plane 220 and/or fabricating the set of features 222 thereof. As another example, additive patterning (e.g., masked deposition, patterned electroplating, area-selective deposition, and/or the like) may be leveraged for patterning the ground plane 220 and/or fabricating the set of features 222 thereof.

### Technical Advantages

Conventionally, the ground plane of a confinement assembly is a conductive sheet or layer. The ground plane is configured to provide a return RF current generated as part of applying an RF voltage signal to at least one RF electrode of the confinement apparatus of the confinement assembly. When the RF voltage signal is characterized by lower frequencies (e.g., 1 kHz), the return RF current distribution is dominated by a resistive current. The resistive current is governed by a real resistive path-length minimization process at least one RF electrode and the load ground point connection. When the RF voltage signal is characterized by higher frequencies (e.g., 1 GHz) the return RF current distribution is dominated by reactive currents which are governed by a minimization of the device impedance. The reactive currents tend to flow along a similar pattern as the driven RF currents. For example, the reactive currents may flow through the ground plane in the same pattern and in corresponding positions as the driven RF currents flowing through the at least one RF electrode (but in opposite direction).

When the RF voltage signal applied to the RF electrodes is characterized by a frequency on the order of 10s of MHz (e.g., 1 to 100 MHz), the return current includes substantial contributions from both reactive currents and resistive currents. The reactive currents mirror the currents in the RF electrodes. The resistive currents, however, will take a more direct path to ground.

As a current necessarily includes moving charged particles, the return RF current generates a magnetic field. The different paths to the load ground point connection of the resistive currents and the reactive currents cause the magnetic field generated by the return RF current to include components in various directions.

Common qubit states in trapped ion and/or QCCD-based quantum computing systems are based on the hyperfine splitting of the atomic objects (e.g., neutral and/or ionic atoms; neutral, ionic, or multipolar molecules; and/or the like) used as the qubits of the quantum computing system. Thus, the qubits states are sensitive to spurious magnetic fields, as the hyperfine splitting energy levels of the atomic objects used as the qubits are due to a coupling of the atomic objects'spin degree of freedom with magnetic fields. Therefore, it is desired to control the return RF currents such that the magnitude and direction of magnetic fields and magnetic field gradients generated by the return RF currents (possibly in combination with the magnetic fields and magnetic field gradients generated by the driven RF currents) are controlled and/or reduced.

Therefore, the magnetic fields generated by the return RF currents may affect the qubit states of the quantum computing system. This may lead to memory errors, lower fidelity quantum logic gates, and/or the like. Thus, technical problems regarding controlling the magnetic field generated by various currents flowing through various layers of a confinement assembly exist.

Various embodiments provide technical solutions to these technical challenges. In particular, the ground plane comprises a set of features that are in electrical communication with one another. The set of features are configured to guide the return RF current to the load ground point connection. For example, the geometry of the ground plane is modified from a conventional ground plane geometry so as to control the path traversed by the various components of the return RF current. For example, the ground plane may be modified to provide a set of effective trace-like domains or features that guide the resistive currents along desired trajectories or paths. In some embodiments, the set of features corresponds to the path the reactive currents would naturally take. For example, the set of engineered features may mimic or mirror the RF electrode geometry of the at least one RF electrode. In various embodiments, the set of features are configured to provide a controlled magnetic field as a result of the reactive and resistive currents flowing therethrough.

Various embodiments provide confinement assemblies that include ground planes comprising a set of features configured to control a path of various components of the return RF current. Various embodiments provide systems that includes such confinement assemblies. In various embodiments, the modified geometry of the ground plane of such embodiments reduces the spurious magnetic fields experienced by atomic objects confined by the confinement apparatus of the confinement assembly. The reduced spurious magnetic fields experienced by the atomic objects results enable higher fidelity of operations performed by the system.

Therefore, various embodiments provide technical improvements to the fields of confinement assemblies, atomic systems including confinement assemblies, quantum systems including confinement assemblies, and QCCD-based and/or atomic qubit quantum computing.

### Example Controller

In various embodiments, a quantum computer 110 comprises a controller 30 configured to control various elements and/or components of the quantum processor 115. In various embodiments, a controller 30 may be configured to cause a quantum computer 110 to perform various operations (e.g., quantum logic operations, cooling operations, measurement operations, shelving/deshelving operations, state preparation operations, atomic object transport operations, and/or the like). For example, the controller 30 may be configured to cause one or more manipulation sources 64 to provide respective manipulation signals configured to enact respective operations, in an example embodiment. In various embodiments, the controller 30 may be configured to control operation of a cryogenic system and/or vacuum system controlling the temperature and pressure within the cryogenic and/or vacuum chamber 40, manipulation sources 64, beam path systems 66, confinement apparatus 235, voltage sources 70, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects confined by the confinement apparatus 50.

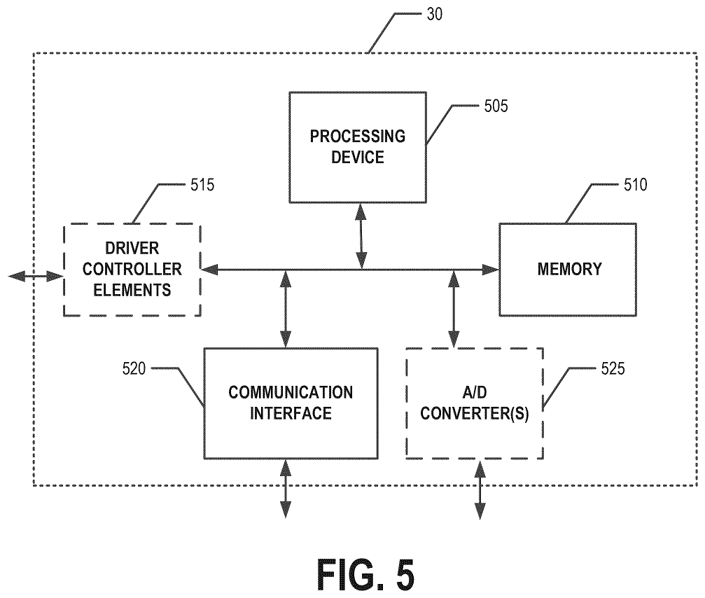

As shown in FIG. 5, in various embodiments, the controller 30 may comprise various controller elements including processing device 505, memory 510, driver controller elements 515, a communication interface 520, analog-digital converter elements 525, and/or the like. For example, the processing device 505 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing device 505 of the controller 30 comprises a clock and/or is in communication with a clock.

For example, the memory 510 may comprise non-transitory (classical and/or semiconductor-based) memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 510 may store qubit records corresponding the qubit ions of the quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 510 (e.g., by a processing device 505) causes the controller 30 to perform one or more steps, operations, processes, procedures and/or the like described herein.

In various embodiments, the driver controller elements 515 may include one or more drivers and/or controller elements each configured to control one or more drivers. In various embodiments, the driver controller elements 515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 505).

In various embodiments, the driver controller elements 515 may enable the controller 30 to operate manipulation sources 64, beam path systems 66, voltage sources 70, the confinement apparatus 235, vacuum and/or cryogenic systems, and/or the like. In various embodiments, the drivers may be laser drivers; microwave drivers; vacuum component drivers; cryogenic and/or vacuum system component drivers; current drivers; potential drivers; voltage sources; and/or the like.

In various embodiments, the controller 30 comprises means for communicating and/or receiving sensor signals from one or more optical receiver components such as photodetectors, cameras, MEMs cameras, CCD cameras, photodiodes, photomultiplier tubes, and/or the like. For example, the controller 30 may comprise one or more analog-digital converter elements 525 configured to receive signals from one or more optical receiver components, calibration sensors, and/or the like. For example, the controller 30 may be configured to receive one or more sensor signals generated by respective photodetectors of the optics collection system and/or other calibration system.

In various embodiments, the controller 30 may comprise a communication interface 520 for interfacing and/or communicating with a computing entity 10. For example, the controller 30 may comprise a communication interface 520 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

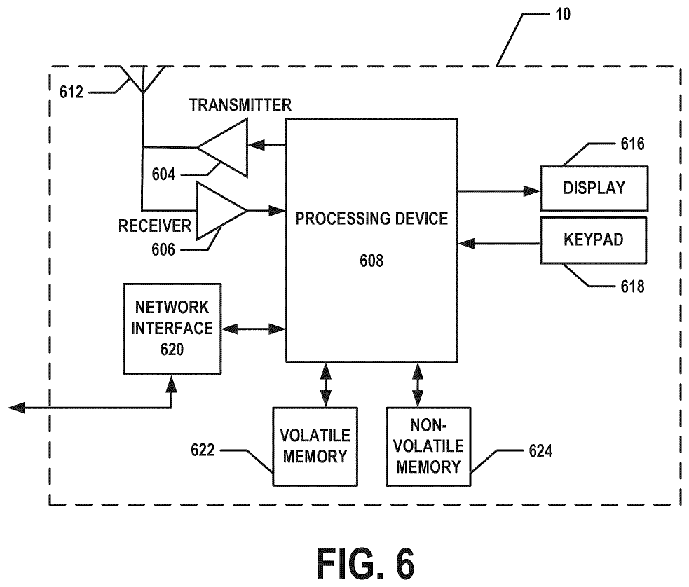

FIG. 6 provides an illustrative schematic representation of an example computing entity 10 that can be used in conjunction with embodiments of the present invention.

In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit that may be provided such that the controller 30 may receive the quantum algorithm and/or quantum circuit and cause the quantum computer 110 to perform the quantum algorithm and/or quantum circuit.

As shown in FIG. 6, a computing entity 10 can include an antenna 612, a transmitter 604 (e.g., radio), a receiver 606 (e.g., radio), and a processing device 608 that provides signals to and receives signals from the transmitter 604 and receiver 606, respectively. The signals provided to and received from the transmitter 604 and the receiver 606, respectively, may include signaling information/data in accordance with an air interface standard of applicable wireless systems to communicate with various entities, such as a controller 30, other computing entities 10, and/or the like.

In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol.

Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA),

Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like. In various embodiments, the computing entity 10 includes a network interface 620 configured to enable the computing entity 10 to communicate via one or more wired and/or wireless networks.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity comprises a processing device 608. For example, the processing device 608 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products.

The computing entity 10 may also comprise a user interface device comprising one or more user input/output interfaces (e.g., a display 616 and/or speaker/speaker driver coupled to a processing device 608 and a touch screen, keyboard, mouse, and/or microphone coupled to a processing device 608). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 618 (hard or soft), a touch display, voice/speech or motion interfaces, scanners, readers, or other input device. In embodiments including a keypad 618, the keypad 618 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 622 and/or non-volatile storage or memory 624, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM,

RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A confinement assembly comprising:
an electrode layer comprising a plurality of electrodes, the plurality of electrodes comprising at least one radio frequency (RF) electrode and operable to generate a confinement potential configured to confine atomic objects;
one or more electrical routing layers configured to provide respective voltage signals to respective electrodes of the plurality of electrodes, the respective voltage signals comprising an RF voltage signal configured to be provided to the at least one RF electrode; and
a ground plane comprising a set of features in electrical communication with one another and with the at least one RF electrode and configured to guide a return RF current to ground, the return RF current generated responsive to the RF voltage signal being provided to the at least one RF electrode.

2. The confinement assembly of claim 1, wherein the RF voltage signal is characterized by a frequency in a range of 1 to 100 MHz.

3. The confinement assembly of claim 1, wherein a geometry of the set of features enables one or more vias to conduct a respective voltage signal to a respective electrode of the plurality of electrodes from the one or more routing layers through the ground plane.

4. The confinement assembly of claim 1, wherein the return RF current comprises a resistive current and a reactive current and a geometry of the set of features is configured to constrain at least a portion of a path of the return RF current.

5. The confinement assembly of claim 1, wherein the geometry of the set of features is configured to cause a return magnetic field generated by the return RF current to at least partially cancel a magnetic field generated by a driven RF current driven in the at least one RF electrode by application of the RF voltage signal thereto.

6. The confinement assembly of claim 5, wherein the return magnetic field is in an opposite direction of the magnetic field generated by the driven RF current.

7. The confinement assembly of claim 5, wherein a cross-sectional area of one or more features of the set of features is configured to control a current density of the return RF current flowing through the one or more features.

8. The confinement assembly of claim 7, wherein the cross-sectional area of the one or more features is configured to control a magnitude of the return magnetic field at one or more locations defined at least in part by the plurality of electrodes.

9. The confinement assembly of claim 8, wherein the return magnetic field at the one or more locations is configured to at least partially cancel out the magnetic field generated by the driven RF current at the one or more locations.

10. The confinement assembly of claim 1, a geometry of at least a subset of the set of features has a same top-down shape as a geometry of a top-down shape of the at least one RF electrode.

11. The confinement assembly of claim 1, wherein the set of features is configured to control a path and a current density of the return RF current.

12. The confinement assembly of claim 11, wherein the set of features is configured to control the path and the current density of the return RF current so as to control a direction and magnitude of a return magnetic field generated by the return RF current.

13. The confinement assembly of claim 11, wherein the confinement assembly comprises one or more metal layers that define the ground plane.

14. A quantum computer comprising:
a plurality of voltage sources configured to generate respective voltage signals, wherein the plurality of voltage sources comprises at least one radio frequency (RF) voltage source configured to generate an RF voltage signal; and
a confinement assembly configured to confine a plurality of atomic objects, the confinement assembly comprising:
an electrode layer comprising a plurality of electrodes, the plurality of electrodes comprising at least one RF electrode and operable to generate a confinement potential configured to confine the plurality of atomic objects;
one or more electrical routing layers configured to provide the respective voltage signals to respective electrodes of the plurality of electrodes, the respective voltage signals comprising the RF voltage signal configured to be provided to the at least one RF electrode; and
one or more metal layers defining a ground plane comprising a set of features in electrical communication with one another and with at least one RF electrode and configured to guide a return RF current to ground, the return RF current generated responsive to the RF voltage signal being provided to the at least one RF electrode.

15. The quantum computer of claim 14, wherein the atomic objects are hyperfine qubits, the return RF current comprises a resistive current and a reactive current, and a geometry of the set of features is configured to constrain a path of the return RF current so as to control a magnetic field generated thereby.

16. The quantum computer of claim 14, wherein the geometry of the set of features is configured to cause a return magnetic field generated by the return RF current to at least partially cancel a magnetic field generated by a driven RF current driven in the at least one RF electrode by application of the RF voltage thereto for at least one target location defined at least in part by the confinement assembly.

17. The quantum computer of claim 14, wherein the one or more metal layers defining the ground plane comprises two or more metal layers.

18. The quantum computer of claim 14, wherein a cross-sectional area of one or more features of the set of features is configured to control a current density of the return RF current flowing through the one or more features, and the current density of the return RF current is configured to control a magnitude of the return magnetic field at one or more locations defined at least in part by the plurality of electrodes, the plurality of electrodes configured to confine one or more of the plurality of atomic objects at respective locations of the one or more locations.

19. The quantum computer of claim 18, wherein the return magnetic field at the one or more locations is configured to at least partially cancel out the magnetic field generated by the driven RF current at the one or more locations.

20. The quantum computer of claim 14, wherein the confinement assembly further comprises an insulator layer disposed between the electrode layer and the ground plane.
